(19) United States
(12) Patent Application Publication
(10) Pub. No.: US 2007/0019709 A1
(43) Pub. Date: Jan. 25, 2007

(54) Structure of temperature sensor of electric heater

(75) Inventor: Yu-Chin Wang, Taipei (TW)

Correspondence Address: BRUCE H. TROXELL, SUITE 1404, 5205 LEESBURG PIKE, FALLS CHURCH, VA, 22041, US

(73) Assignee: Eiko Electric Products Corp.

(21) Appl. No.: 11/184,968

(22) Filed: Jul. 20, 2005

(51) Int. Cl. G01K 1/00

(52) U.S. Cl. 374/208

(57) ABSTRACT

An improved structure of a temperature sensor of an electric heater being provided with an outer pipe of which one end is tightly sealed, and being provided therein with a plurality of electric heating elements positioned on a supporting plate and connected with a control circuit board for electric conducting from an external power supply, the control circuit board is provided with a high-temperature sensing element, the high-temperature sensing element is serially connected on the control circuit board with a water-temperature sensing element. Thereby a safer function of use can be provided when the structure works under water wherein the electric heating elements can be automatically shut.

### BACKGROUND OF THE INVENTION

1. Field of the invention

The present invention is related to an improved structure of a temperature sensor of an electric heater, and especially to an electric heating device suiting a set of equipment such as an aquarium, the structure can increase the safety of such an electric heater.

2. Description of the Prior Art

An electric heating pipe used for a set of equipment such as an aquarium mainly is provided to control the temperature in the aquarium, so that fishes bred in the aquarium can be alive. Generally, an electric heating pipe of such a set of equipment of aquarium is provided with a structure for thermostatic control.

By virtue that an aquarium must have its heating function controlled by setting temperature of water, taking the temperature of water being set as 25° C. as an example, such an electric heater normally functions when the temperature of water is lower than a set temperature, and stops being turned on for heating when the temperature of water is higher than the set temperature. In order to get the stated functions, such electric heaters available nowadays are required to be installed therein with various structure types of temperature-sensing controllers.

As shown in FIG. 1, such an electric heating pipe generally is provided in a tightly sealed glass pipe 10 with more than one strip of electric heating element 11 for supplying electric power for heating, the temperature-sensing controller used for this mainly is a thermal reed switch (a magnetic thermal reed switch) 12. By means of the thermal reed switch 12, the electric heating element 11 is stopped being turned on for heating when the temperature of water is higher than a set temperature; or the electric heating element 11 is turned on for heating when the temperature of water is lower than the set temperature. However, the defect of such a conventional electric heating pipe is that a larger volume can be formed to occupy a larger space, and its stability of operation is not ideal either.

FIG. 2 shows another conventional temperature-sensing structure of an electric heating pipe, in an outer tightly sealed glass pipe of the temperature-sensing structure there is also more than one strip of electric heating coil for supplying electric power for heating, a device of the temperature-sensing structure for performing the above stated temperature-sensing controlling mainly is a temperature switch 13. Such a conventional electric heating pipe is that a larger volume can be formed, and that a heating portion is completely separated from a control circuit portion, this makes more trouble as well as inconvenience in the process of production, and the cost for working hours are also higher.

In view of the above defects of the temperature-sensing controller of conventional electric heaters, some added a single temperature sensor such as a heat sensitive switch to a control circuit board; nevertheless, it still derives unsafe factors. For example, when an aquarium is broken in an accident or a natural disaster (such as an earthquake), the above stated electric heating coil probably is still under control for heating. Taking the winter times in Europe and America as an example, the temperature outside of an aquarium (or fish jar) normally is far lower than the set temperature (such as 25° C.), hence even under the situation that water in the aquarium has been exhausted, the above stated electric heating coil is still in the state of being turned on for heating, thereby conflagration can be induced.

### SUMMARY OF THE INVENTION

The main object of the present invention is to provide an improved structure of a temperature sensor of an electric heater, the structure can increase safety in use and can prevent occurrence of an accident.

A further object of the present invention is to provide an improved structure of a temperature sensor of an electric heater, of which sensing elements and an electric circuit element are formed to be integrated with each other; this makes fast and convenient manufacturing.

To obtain the object, the present invention is provided with an outer pipe of which one end is tightly sealed, and is provided therein with a plurality of electric heating elements positioned on a supporting plate and connected with a control circuit board for electric conducting from an external power supply; the control circuit board is provided with a high-temperature sensing element, the high-temperature sensing element is serially connected on the control circuit board with a water-temperature sensing element.

In a preferred embodiment, the high-temperature sensing element and the water-temperature sensing element are heat sensitive electric resistances such as resistances with negative temperature coefficients.

In the feasible embodiment, the high-temperature sensing element is provided on a surface of the control circuit board and is close to an inner wall of the outer pipe; the water-temperature sensing element is provided on the supporting plate having the electric heating elements.

The present invention will be apparent in its novelty and features after reading the detailed description of the preferred embodiment thereof in reference to the accompanying drawings.

### BRIEF DESCRIPTION OF THE DRAWINGS

FIG. 1 is a perspective view showing the structure of a conventional temperature sensitive electric heater;

FIG. 2 is a perspective view showing the structure of another conventional temperature sensitive electric heater;

FIG. 3 is a perspective view of a preferred embodiment of the present invention;

FIG. 4 is an anatomic perspective view showing the elements of FIG. 3;

FIG. 5 is a circuit diagram of the preferred embodiment of the present invention.

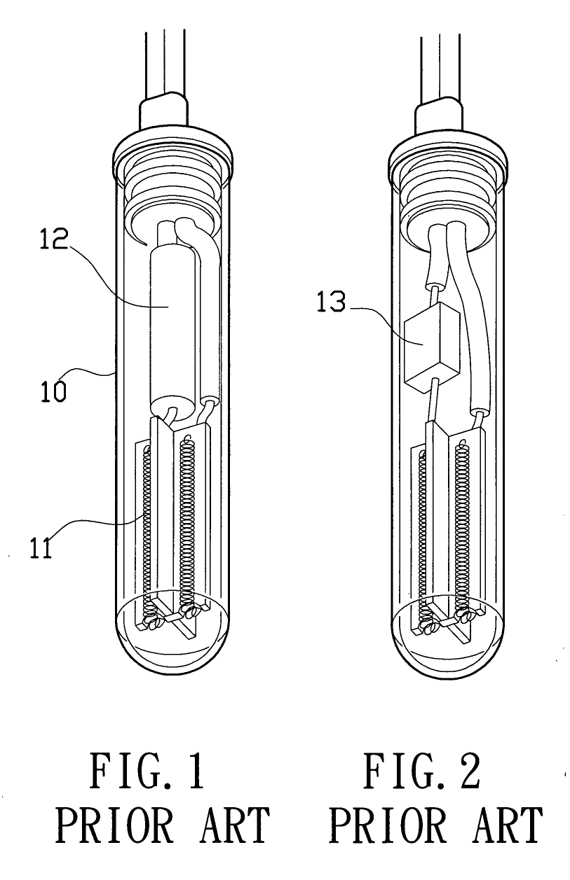

### DETAILED DESCRIPTION OF THE PREFERRED EMBODIMENT

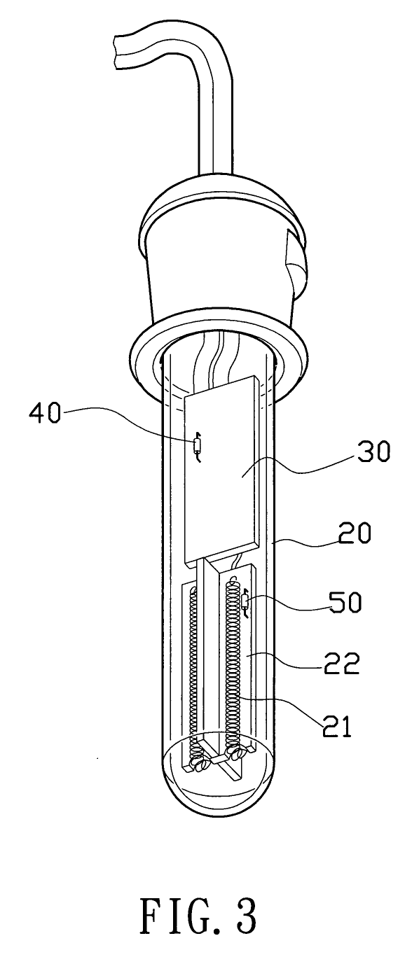

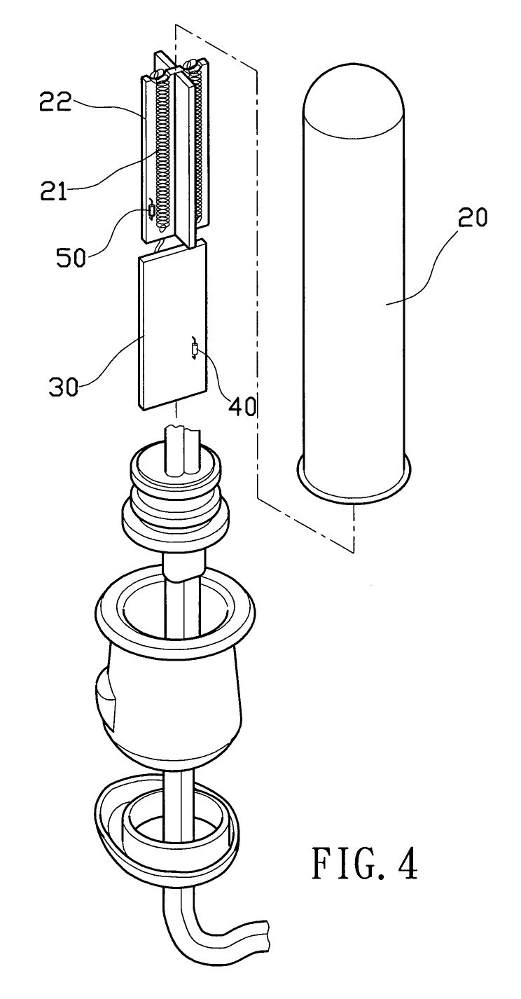

Referring to FIGS. 3 and 4, in the preferred embodiment shown, the electric heater of the present invention is provided with an outer pipe 20 of which one end is tightly sealed, and is provided therein with a plurality of electric heating elements 21 positioned on a supporting plate 22 and connected with a control circuit board 30 for electric conducting from an external power supply; the control circuit board 30 is provided with a high-temperature sensing element 40, the high-temperature sensing element 40 is serially connected with a water-temperature sensing element 50. In the preferred embodiment shown, the high-temperature sensing element 40 is provided on a surface of the control circuit board 30 and is close to an inner wall of the outer pipe 20; the water-temperature sensing element 50 is provided on the supporting plate 22 with the electric heating elements 21.

In the preferred embodiment shown, the high-temperature sensing element 40 and the water-temperature sensing element 50 are heat sensitive electric resistances preferably with negative temperature coefficients (NTC), the advantage of using such heat sensitive electric resistances is that, their resistances are higher in lower temperatures, and are lower in higher temperatures; their resistances are quite sensitive to temperature.

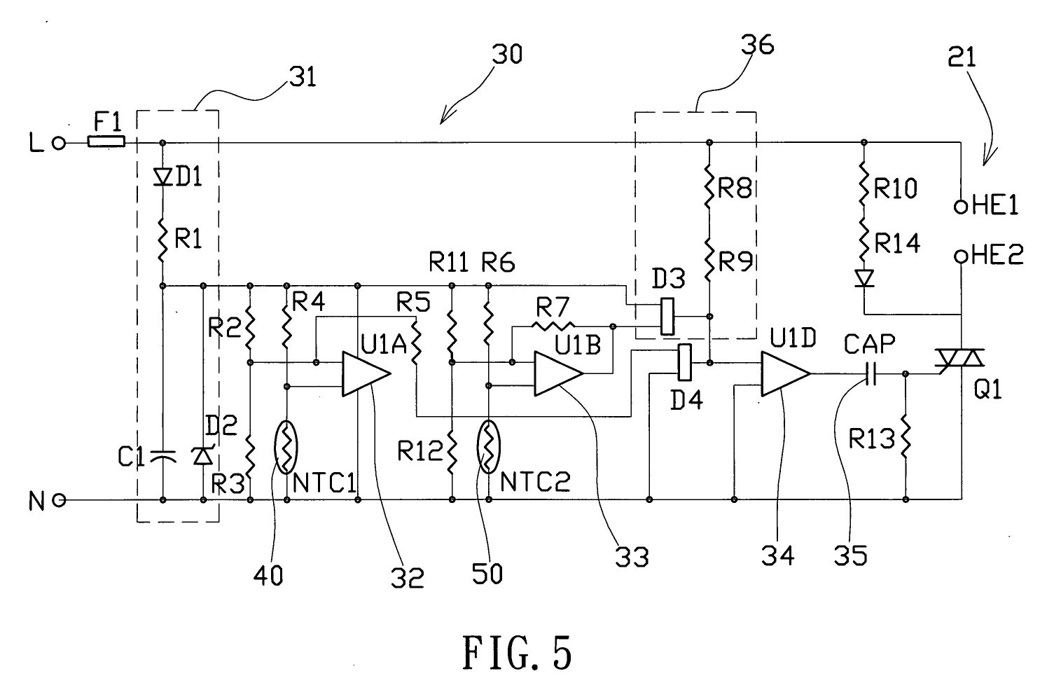

Referring to FIG. 5, in a circuit diagram of the preferred embodiment of the present invention, the circuit of the control circuit board 30 is serially connected with the high-temperature sensing element 40 (NTC1) and the water-temperature sensing element 50 (NTC2); the input voltage of the electric source is supplied for the above stated sensing elements 40, 50 through a current rectifying and wave filtering voltage stabilizer circuit 31 (D1, R1, C1, D2). A high-temperature sensing circuit 32 (U1A) and a water-temperature sensing circuit 33 (U1B) give reference voltages for comparing with reference voltage circuits (R2, R3, R11, R12).

When the temperature is increased in operation of the present invention, the impedance of the high-temperature sensing element 40 (NTC1) is lowered, it is provided that the voltage of one pin of the high-temperature sensing circuit 32 (U1A) is lowered, when the voltage is lower than that of another pin, a voltage comparator circuit 34 (U1D) outputs electric voltage with a high level, so that an SCR (Q1) does not work to get a function of protection in high temperature.

When the temperature is increased, the impedance of the water-temperature sensing element 50 (NTC2) is lowered too, the voltage of one pin of the water-temperature sensing circuit 33 (U1B) is lowered, when the voltage is lower than that of a fifth pin, one pin of the voltage comparator circuit 34 (U1D) has an electric voltage with a high level too.

When the temperature is reduced, the voltage of one pin of the water-temperature sensing circuit 33 (U1B) will be higher than that of another pin, so that the water-temperature sensing circuit 33 (U1B) outputs electric voltage with a low level, this makes the signal on one pin of the voltage comparator circuit 34 (U1D) an alternative signal changing in accordance with the change of frequency of the power source, this alternative signal is a signal of 0-VCC. And the alternative signal is conducted via a differentiating capacitor 35 by control of the SCR (Q1) to get a function of controlling water temperature.

The above-mentioned voltage comparator circuit 34 (U1D) is a voltage comparator circuit for comparing with the ground, when the voltage of one pin of the high-temperature sensing circuit 32 (U1A) and the water-temperature sensing circuit 33 (U1B) output electric voltages with low levels, the signal on one pin of the voltage comparator circuit 34 (U1D) is in the state as below: when the input voltage is a positive voltage, the voltage gives the said one pin a positive signal output with a high level through a signal comparator circuit 36 (R8, R9, D3); on the contrary, when the input voltage is a negative voltage, the voltage gives the said one pin a negative signal output with a low level through the signal comparator circuit 36 (R8, R9, D3). The out signals with the high and low levels are differentiated through the differentiating capacitor 35 to get triggering signals for controlling the electric heating elements 21 by the SCR (Q1).

In working under water of the above stated circuit structure, the signal sensed by the high-temperature sensing circuit 32 (U1A) is higher than the voltage of the comparing signal, hence its output is of a low level; when not in working under water, the signal sensed by the high-temperature sensing circuit 32 (U1A) is lower than the voltage of the comparing signal, hence its output is of a high level able to control the voltage comparator circuit 34 (U1D) to render the circuit to not work.

The present invention with the above stated improved structure thereby can make the high-temperature sensing circuit 32 (U1A) and the water-temperature sensing circuit 33 (U1B) connected serially with each other be simultaneously shut automatically when it is used for a set of equipment such as an aquarium, even under the condition when the water in the equipment is accidentally exhausted by flowing out or is dried to make it be in the state of working in a none water space; thus a safer function of use can be provided to prevent an accident. And the sensing elements as well as the control circuit elements are integrally connected; this makes manufacturing more convenient.

The embodiment given is only for illustrating the present invention, and not for giving any limitation to the scope of the present invention. It will be apparent to those skilled in this art that various modifications or changes without departing from the spirit of this invention shall also fall within the scope of the appended claims.

1. An improved structure of a temperature sensor of an electric heater, said electric heater is provided with an outer pipe of which one end is tightly sealed, and is provided therein with a plurality of electric heating elements positioned on a supporting plate and connected with a control circuit board for electric conducting from an external power supply; said structure is characterized in that: said control circuit board is provided with a high-temperature sensing element, said high-temperature sensing element is serially connected on said control circuit board with a water-temperature sensing element.

2. The improved structure of a temperature sensor of an electric heater as claimed in claim 1, wherein
said high-temperature sensing element and said water-temperature sensing element are electric resistances with negative temperature coefficients.

3. The improved structure of a temperature sensor of an electric heater as claimed in claim 1, wherein
said high-temperature sensing element is provided on a surface of said control circuit board and is close to an inner wall of said outer pipe; said water-temperature sensing element is provided on said supporting plate having said electric heating elements.
